(19) United States
(12) Patent Application Publication
(10) Pub. No.: US 2009/0216481 A1
(43) Pub. Date: Aug. 27, 2009

(54) Method and System for Assessing Reactor Fluidization Quality and Operability From Frequency Spectrum of Temperature Data

(75) Inventors: Eric J. Markel, Kingwood, TX (US); Michael E. Muhle, Kingwood, TX (US)

Correspondence Address: UNIVATION TECHNOLOGIES, LLC, 5555 SAN FELIPE, SUITE 1950, HOUSTON, TX, 77056, US

(73) Assignee: Univation Technolgies, LLC, Houston, TX (US)

(21) Appl. No.: 11/886,643

(22) PCT Filed: Feb. 21, 2006
(86) PCT No.: PCT/US2006/006024

§ 371 Date: Feb. 12, 2009

Related U.S. Application Data
(60) Provisional application No. 60/667,292, filed on Mar. 31, 2005.

(51) Int. Cl. G06F 15/00; G01K 13/00

(52) U.S. Cl. 702/130; 702/182

(57) ABSTRACT

In some embodiments, a method or system for assessing fluidization quality of a fluidized bed reactor, including by: (a) generating at least one set of temperature data indicative of temperature at a location within the reactor as a function of time during operation of the reactor; (b) generating transformed data by performing a Fourier transform on each said set of temperature data; (c) generating filtered, transformed data by high-pass filtering the transformed data to remove low frequency components thereof (preferably including the frequency component whose frequency is the natural frequency of the cooling control loop); and (d) determining at least one indication of the fluidization quality from the filtered, transformed data. In some embodiments, the reactor has a cooling control loop having a natural frequency and the frequency components removed during step (c) include a frequency component whose frequency is the natural frequency. In some embodiments, step (a) includes the step of generating at least two sets of skin temperature data, each indicative of skin temperature as a function of time at a different elevation within the fluidized bed. Some embodiments enable diagnosis of poor fluidization or mixing in the bed of a fluidized bed reactor, by analyzing Fourier-transformed, filtered skin temperature data.

### CROSS-REFERENCE TO RELATED APPLICATIONS

This application claims the benefit of Provisional Application No. 60/667,292, filed Mar. 31, 2005, the disclosure of which is incorporated by reference.

### FIELD OF THE INVENTION

The invention pertains to methods and systems for assessing fluidization quality and operability of fluidized bed reactors (e.g., fluidized bed reactors operating to produce polyolefins). Some embodiments of the invention are methods and systems for assessing the fluidization quality of fluidized bed reactors from the frequency spectra of temperature data (indicative of temperature at one or more locations in each reactor as a function of time during operation of the reactor).

### BACKGROUND OF THE INVENTION

“Skin temperature” denotes reactor temperature measured at a point very close to the vessel surface or “skin”, hence the name skin temperature and skin thermocouple. The distance of a skin temperature sensor from a reactor wall is typically 1/16 to ¼ inch but a temperature measured at a distance from 0 to 8 inches from the reactor wall is considered a skin temperature in typical embodiments of the invention. “Bed temperatures” are those temperatures measured closer to the centerline of a reactor. A bed temperature is measured at a distance of 8 inches or more from the reactor wall in typical embodiments of the invention.

The expression “temperature data” herein denotes data indicative of a temperature function, T(t), specifying a temperature at each time “t” of a continuous range or discrete set of times. Typically, the temperature function specifies a temperature at a location within a reactor (e.g., a skin temperature at a location within the reactor near the reactor wall) at each time “t” of a continuous range or discrete set of times during reactor operation.

The expression “Fourier transform” (in the context of performing a Fourier transform on temperature data) herein denotes a Fourier transform (in the strictly defined sense) or, where meaningful in the context, a cosine transform or sine transform.

The expression “frequency spectrum” is used herein as a synonym for “frequency-amplitude spectrum.” The result of performing a Fourier transform on temperature data (indicative of a temperature function, T(t)) is a set of transformed data indicative of the frequency spectrum of the temperature function, T(t).

In the context of high-pass filtering data to “remove” low frequency components of the data, the term “remove” herein denotes completely reducing (i.e., to zero) or substantially reducing the amplitude of such low frequency components.

In operation, a fluidized bed reactor includes material having relatively low volumetric concentration of particulates (“lean phase” material) and material having greater volumetric concentration of particulates (“dense-phase” material) than the lean phase material. In typical operation of a fluidized bed reactor, there is a boundary (known as a “dense-phase surface”) between lean phase material and dense-phase material (below the lean phase material) in the reactor. The expression “freeboard surface” of a fluidized bed reactor herein denotes the portion of the reactor's interior surface above the dense-phase surface.

One commonly used method for producing polymers is gas phase polymerization. A conventional gas phase fluidized bed reactor used to produce polyolefins by polymerization contains a fluidized dense-phase bed including a mixture of reaction gas and polymer (resin) particles. During operation, a portion of such a reactor's interior surface is a “freeboard surface” as defined above. A “freeboard volume” within the reactor (bounded by the freeboard surface and dense-phase surface) contains mainly gas and a small amount of particles, e.g., fine particles (fines). The dense-phase bed is usually maintained in a straight (cylindrical) section of the reactor. Above the straight section, the reactor often has an “expanded” section whose diameter is larger than that of the straight section to reduce the velocity of gas flowing therethrough (to reduce the amount of fines carried out of the reactor to other parts of the reaction system). The freeboard surface typically includes the interior surface of the expanded section, and (when the bed level is lower than the top of the straight section) an upper portion of the straight section's interior surface.

During operation of a fluidized bed reactor of the above-described type, fines present in the freeboard volume are either carried away by gas leaving the reactor or they fall back into the dense-phase bed. However, some fines can become attached to the interior surface of the reactor system (e.g., at locations on the freeboard surface or within the bed), and can contribute to formation of layers (“sheets”) of agglomerated, melted or half-melted, resin and catalyst particles on the interior surface. Sheets can adversely affect properties of the polymer product. When sheets become heavy, they can fall off the reactor wall and plug the product discharge system or clog the distributor plate. Small pieces of sheets can be discharged together with the bulk resin particles and contribute to product quality problems by increasing the gel level of end-use products such as plastic containers and films.

Background references include U.S. Patent Application Nos. 2002/103072, 2003/121330, 2004/132931; U.S. Pat. Nos. 4,858,144, 5,672,666, 6,743,870; WO 1999/02573, WO 2000/032652; JP 05086109/JP3138773; CA 2 178 238 and Hendrickson, Gregory (available online Aug. 29, 2005) Electrostatics and Gas Phase Fluidized Bed Polymerization Reactor Wall Sheeting, 61 CHEM. ENG. SCI., Elsevier, 1041-1064 (2006).

### SUMMARY OF THE INVENTION

In a class of embodiments, the invention is a method for assessing fluidization quality of a fluidized bed reactor, said method including the steps of:

(a) generating at least one set of temperature data, such that each said set of temperature data is indicative of temperature at a location within the reactor as a function of time during operation of the reactor;

(b) generating transformed data by performing a Fourier transform on each said set of temperature data;

(c) generating filtered, transformed data by high-pass filtering the transformed data to remove low frequency components thereof; and

(d) determining at least one indication of the fluidization quality from the filtered, transformed data.

In typical embodiments in this class, the reactor has a cooling control loop having a natural frequency and the low frequency components removed during step (c) include a frequency component whose frequency is said natural frequency. In typical implementations, the natural frequency (f_{N}) of the reactor's cooling control loop is the natural frequency at which the temperature of cooling fluid (entering the bottom of the fluidized bed) varies during reactor operation.

In some embodiments in the noted class, step (a) includes the step of generating at least two sets of skin temperature data, each indicative of skin temperature as a function of time at a different elevation within the fluidized bed. In some embodiments, step (a) also includes the step of generating a set of bed temperature data indicative of bed temperature at a location relatively far from the reactor wall (as a function of time). In some embodiments, step (a) includes the steps of using thermocouple sensors (or other sensors) to generate a first set of temperature data indicative of skin temperature as a function of time at a first elevation within the fluidized bed (e.g., above a distributor plate), and a second set of temperature data indicative of skin temperature as a function of time at a second elevation (above the first elevation) within the fluidized bed. Typically, the thermocouple sensors include at least one sensor positioned along a lower section of the fluidized bed, and at least one other sensor positioned along a higher section of the fluidized bed.

In some embodiments, step (d) includes the step of determining whether the filtered, transformed data are indicative of at least one diffuse frequency spectrum, preferably in the sense that the filtered, transformed data are indicative of at least one frequency spectrum whose average amplitude exceeds a predetermined minimum value (typically 150%, or more than 150%, of the average frequency spectrum amplitude for normal operation) over a broad frequency range (typically 0-5 cycles per minute). For example, in some embodiments in which the fluidized bed reactor is an mLLDPE (metallocene-catalyzed, linear low-density polyethylene) reactor, the broad frequency range is from 0 to 1.5 cycles per minute. Filtered, transformed data that are not indicative of a diffuse frequency spectrum are typically considered to be an indication of poor fluidization quality (and typically also of unstable reactor operation likely to result in sheeting). Filtered, transformed data that are indicative of a diffuse frequency spectrum are in some cases considered an indication of good fluidization quality and in other cases considered an indication that additional analysis is required to determine fluidization quality.

In some embodiments, step (a) includes the step of generating at least two sets of skin temperature data, including a first set of temperature data indicative of skin temperature as a function of time at a first elevation within the fluidized bed and a second set of temperature data indicative of skin temperature as a function of time at a second elevation (above the first elevation) within the fluidized bed, step (c) includes the steps of generating a first set of filtered, transformed data from a transformed version of the first set of temperature data and generating a second set of filtered, transformed data from a transformed version of the second set of temperature data, and step (d) includes the step of determining whether the second set of filtered, transformed data has greater average amplitude, A₂, over a frequency range, than the average amplitude, A₁, of the first set of filtered, transformed data over the same frequency range. Determination that A₂ is substantially greater than A₁ is typically considered an indication of poor fluidization quality (and typically also of unstable reactor operation likely to result in sheeting). Determination that A₂ is not substantially greater than A₁ is in some cases considered an indication of good fluidization quality and in other cases considered an indication that additional analysis is required to determine fluidization quality.

In some embodiments of the type described in the preceding paragraph, step (d) also includes the step of determining whether the second set of filtered, transformed data has a greater ratio of low frequency content to high frequency content than does the first set of filtered, transformed data. This can be accomplished by partitioning the frequency range into a first segment (including frequencies less than a threshold frequency, fₜₕ, but no frequencies greater than fₜₕ) and a second segment (including frequencies greater than fₜₕ, but no frequencies less than fₜₕ), and determining an average amplitude, A₂ₗ (where “l” denotes relatively low frequency) of the second set of filtered, transformed data over the first segment of the frequency range, an average amplitude, A₂ₕ (where “h” denotes relatively high frequency) of the second set of filtered, transformed data over the second segment of the frequency range, an average amplitude, A₁ₗ, of the first set of filtered, transformed data over the first segment of the frequency range, and an average amplitude, A₁ₕ, of the first set of filtered, transformed data over the second segment of the frequency range, and determining the relation between the ratios (A₂ₗ/A₂ₕ) and (A₁ₗ/A₁ₕ), for example by determining whether (A₂ₗ/A₂ₕ) is greater than (A₁ₗ/A₁ₕ). Determination that (A₂ₗ/A₂ₕ) is substantially greater than (A₁ₗ/A₁ₕ) is typically considered an indication of good fluidization quality (and typically also of stable reactor operation unlikely to result in significant sheeting), and determination that (A₂ₗ/A₂ₕ) is not substantially greater than (A₁ₗ/A₁ₕ) is typically considered an indication of poor fluidization quality (and typically also of unstable reactor operation likely to result in sheeting).

In some embodiments, step (a) includes the step of generating at least two (e.g., more than two) sets of skin temperature data, including a first set of temperature data indicative of skin temperature as a function of time (during a first time interval) at a first elevation within the fluidized bed, and a second set of temperature data indicative of skin temperature as a function of time (during a second time interval later than the first time interval) at the first elevation within the fluidized bed (and optionally also additional sets of temperature data indicative of skin temperature as a function of time during intervals later than the second time interval), step (c) includes the steps of generating a first set of filtered, transformed data from a transformed version of the first set of temperature data, and generating a second set of filtered, transformed data from a transformed version of the second set of temperature data, and step (d) includes the steps of identifying a frequency range and determining whether the second set of filtered, transformed data has greater average amplitude over the frequency range than does the first set of filtered, transformed data. Determination in step (d) that the second set of filtered, transformed data has greater average amplitude over the frequency range than does the first set of filtered, transformed data is an indication of rising skin temperature in the frequency range, and is typically considered an indication of poor fluidization quality (and typically also of unstable reactor operation likely to result in sheeting). Typically, the first elevation is in a lower portion of the bed, and determination in step (d) that the second set of filtered, transformed data has greater average amplitude over the frequency range than does the first set of filtered, transformed data is considered an indication of poor fluidization quality. In other embodiments, step (c) includes the steps of generating a set of filtered, transformed data from a transformed version of each of N sets of temperature data, each set of temperature data indicative of skin temperature as a function of time during a different time interval (where N is any integer greater than two), and step (d) includes the steps of comparing all or some of the sets of filtered, transformed data statistically to assess reactor spatial uniformity and/or to assess a reactor upset over time.

In a class of embodiments, the invention is a method for measuring and/or diagnosing poor fluidization (and/or mixing) in the bed of a fluidized bed reactor, by analyzing Fourier-transformed skin temperature data. Typically, the Fourier-transformed skin temperature data are generated by transforming (and typically also high-pass filtering) skin temperature data obtained during operation of the reactor using fast responding thermocouple sensors or other fast responding skin temperature sensors. Poor fluidization typically causes poor mixing in lower portions of the fluidized bed and sheeting. Poor mixing is one cause of hot spots, where a reaction product (e.g., polymer) melts to form sheets, agglomerates, and/or chunks. The problem of poor mixing and hot spots is particularly severe as catalyst productivities increase (e.g., when advanced catalysts are used), as reactor space time yields increase (heat of reaction per unit volume), where advanced catalysts are used, and as particle size distributions within the reactor broaden.

Another aspect of the invention is a system configured to perform any embodiment of the inventive method. Such a system typically includes a set of temperature sensors (e.g., skin temperature sensors 5, 6, 7, and 8, and optionally also sensor 9, of FIG. 1) and a processor coupled and configured to receive temperature data from the sensors and to process the temperature data in accordance with the invention (including by performing any required transform and/or filtering operation thereon).

Business losses that can result from poor fluidization include decreased production rates in response to sheeting, unplanned plant shutdowns due to chunks or inoperative auxiliary equipment, and longer cycle time in technology development. Practical corrective actions that can be taken in response to an assessment (in accordance with the invention) of poor fluidization include adjustments in reactor temperature, pressure, superficial velocity, ethylene partial pressure, catalyst productivity/particle size/particle size distribution, production rate, and induced condensing agent (ICA) concentrations. Other corrective actions include the injection of catalyst poisons to deactivate the catalyst particles that are overheating, and addition of continuity aides such as ethoxylated amines, anti-static or conductivity modifiers such as the Octastat family of compounds sold by Octel Performance Chemicals, metal fatty acids such as aluminum distearate, and similar compounds with a known propensity to modify the adherence of properties of polymers to metal surfaces. Embodiments of the inventive method that provide rapid feedback on the impact of process adjustments on fluidization are particularly useful. It is expected that many embodiments of the invention can provide feedback on fluidization quality sufficiently rapidly to warn of poor fluidization before sheeting even occurs.

### BRIEF DESCRIPTION OF THE DRAWINGS

FIG. 1 is a simplified cross-sectional view of a system including fluidized bed reactor (10), four skin temperature sensors (5, 6, 7, and 8) mounted in positions for sensing skin temperature (of the bed very near to the reactor wall), and a resistance temperature sensor (9) for sensing the bed temperature farther from the reactor wall.

FIG. 2 is a simplified cross-sectional view of another fluidized bed reactor whose operation can be assessed in accordance with the invention.

FIG. 3 is a simplified cross-sectional view of another fluidized bed reactor whose operation can be assessed in accordance with the invention.

FIG. 4 is a graph of temperature data from sensors 5, 6, 7, 8, and 9 of FIG. 1 under conditions that resulted in sheeting.

FIG. 5 is a graph of temperature data from sensors 5, 6, 7, 8, and 9 of FIG. 1 under conditions that did not result in significant sheeting.

FIG. 6 is a graph of Fourier-transformed temperature data, and a high-pass filtered version of the same data.

FIG. 7 is a graph of high-pass filtered, transformed data obtained by Fourier-transforming and then high-pass filtering a set of skin temperature data obtained from each of sensors 5, 6, 7, and 8 of FIG. 1 under conditions that did not result in significant sheeting.

FIG. 8 is a graph of high-pass filtered, transformed data obtained by Fourier-transforming and then high-pass filtering a set of skin temperature data obtained from each of sensors 5, 6, 7, and 8 of FIG. 1 under conditions that resulted in significant sheeting.

### DETAILED DESCRIPTION OF PREFERRED EMBODIMENTS

Definitions appearing in the BACKGROUND OF THE INVENTION may be incorporated into this section as applicable and will not repeated to avoid redundancy.

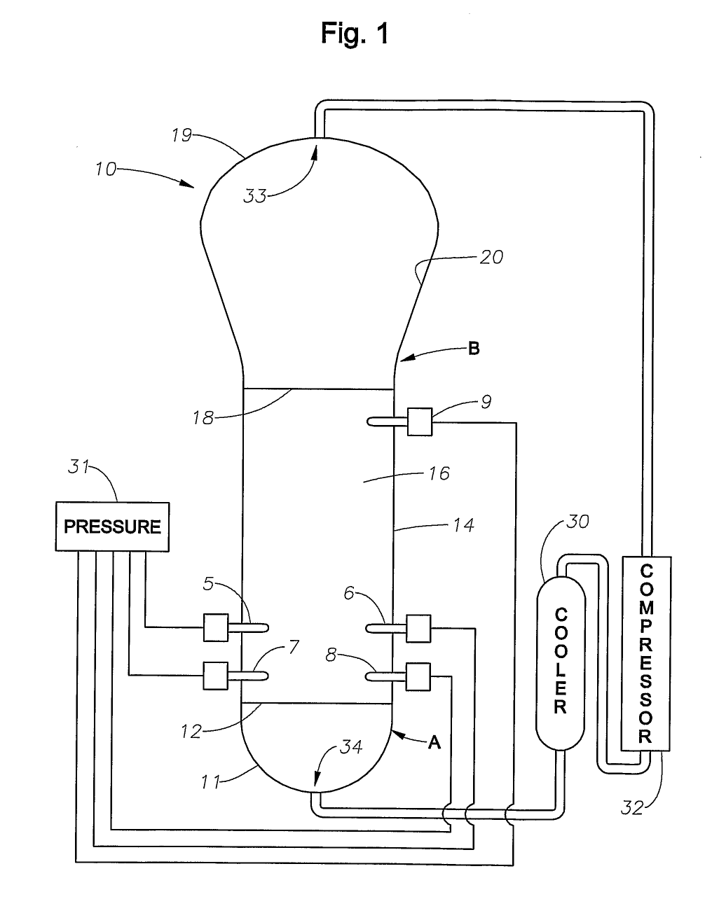

A reactor system whose operation can be assessed in accordance with the invention will be described with reference to FIG. 1. The FIG. 1 system includes fluidized bed reactor 10. Reactor 10 has a bottom end 11, a top section 19, a cylindrical (straight) section 14 between bottom end 11 and top section 19, and a distributor plate 12 within section 14. The diameter of each horizontal cross-section of section 19 is greater than the diameter of straight section 14. In operation, dense-phase surface 18 is the boundary between lean phase material present within reactor 10 (above dense-phase surface 18) and dense-phase material 16 within reactor 10 (in the volume bounded by section 14, plate 12, and surface 18). In operation, freeboard surface 20 of reactor 10 includes the inner surface of top section 19 and the portion of the inner surface of section 14 above surface 18.

The FIG. 1 system also has a cooling control loop which includes circulating gas cooler 30 and compressor 32, coupled with reactor 10 as shown. During operation, the cooled circulating gas flows from cooler 30 through inlet 34 into reactor 10, then propagates upward through the bed and out from reactor 10 via outlet 33. The cooling fluid (whose temperature has increased during its flow through reactor 10) is pumped by compressor 32 from outlet 33 back to cooler 30. Temperature sensors (not shown) near the inlet and outlet of cooler 30 provide feedback to cooler 30 and/or compressor 32 to control the amount by which cooler 30 reduces the temperature of the fluid entering its inlet and/or flow rate through compressor 32. Due to such factors as its time delay for responding to changes in the temperature feedback, the cooling control loop of FIG. 1 has a natural frequency. If temperature data, indicative of the temperature (as a function of time) of the cooling fluid that enters reactor 10's inlet 34, are Fourier transformed, the frequency spectrum of the resulting transformed data will have a spike at the natural frequency.

The FIG. 1 system also includes four “skin temperature” sensors 5, 6, 7, and 8 (typically implemented as thermocouple sensors having fast response design), mounted in positions along straight section 14 of the reactor wall so as to protrude into the bed from the reactor wall by a small amount (e.g., one eighth of an inch). Sensors 5-8 are configured and positioned to sense skin temperature (i.e., bed temperature very near to the wall of reactor 10) during reactor operation.

The FIG. 1 system also includes resistance temperature sensor 9 which is positioned and configured to sense bed temperature during reactor operation at a location within reactor 10 away from the reactor wall. Resistance temperature sensor 9 is mounted so as to protrude into the bed (e.g., 8 to 18 inches away from the reactor wall) more deeply than does sensor 5, 6, 7, or 8. Typically, resistance temperature sensor 9 would be positioned within a suitable thermowell that extends into the bed by a sufficient amount. Such a thermowell can protect sensor 9 from abrasive conditions to which it would otherwise be exposed during reactor operation and allow sensor 9 to be removed and replaced without requiring a reactor shutdown.

Each of sensors 5, 6, 7, 8, and 9 is coupled to processor 31. Processor 31 is configured to receive temperature data from each of sensors 5, 6, 7, 8, and 9, and to process the temperature data in accordance with the invention (including by performing any required transform and/or filtering operation thereon). In typical implementations, processor 31 is programmed with software to implement at least one embodiment of the inventive method, and is configured to generate data indicative (in accordance with the relevant embodiment of the invention) of an assessment of fluidization quality of reactor 10.

Reactor 10 can be implemented as a mLLDPE (metallocene-catalyzed, linear low-density polyethylene) reactor, with straight section 14 having height 47 feet, six inches (from point A to point B) and distributor plate 12 positioned three feet, one inch above point A. Assuming such an implementation of reactor 10, skin temperature sensors 7 and 8 can be positioned about three feet above plate 12 (in azimuthal positions of about 0 and 180 degrees, respectively, with respect to the central longitudinal axis of the reactor), skin temperature sensor 5 can be positioned eight feet, three inches, above plate 12 (preferably in an azimuthal position of about 300 degrees with respect to the reactor's central longitudinal axis, or alternatively an azimuthal position of about 180 degrees with respect to the reactor's central longitudinal axis as shown), skin temperature sensor 6 can be positioned seven feet, three inches, above plate 12 (in an azimuthal position of about 180 degrees with respect to the reactor's central longitudinal axis), and bed temperature sensor 9 can be positioned about thirty-three feet above plate 12. For use with the described implementation of reactor 10, skin temperature sensors 5-8 can be Type K thermocouple sensors of the type available from Conax Buffalo Technologies, of Buffalo, N.Y.

In other implementations, skin temperature sensors 5-8 are positioned with uniform azimuthal spacing around the reactor's central longitudinal axis (i.e., with an azimuthal position difference of about 90 degrees between each pair of adjacent sensors). More generally, skin temperature sensors can be positioned in any of many different azimuthal or longitudinal positions in various embodiments of the invention.

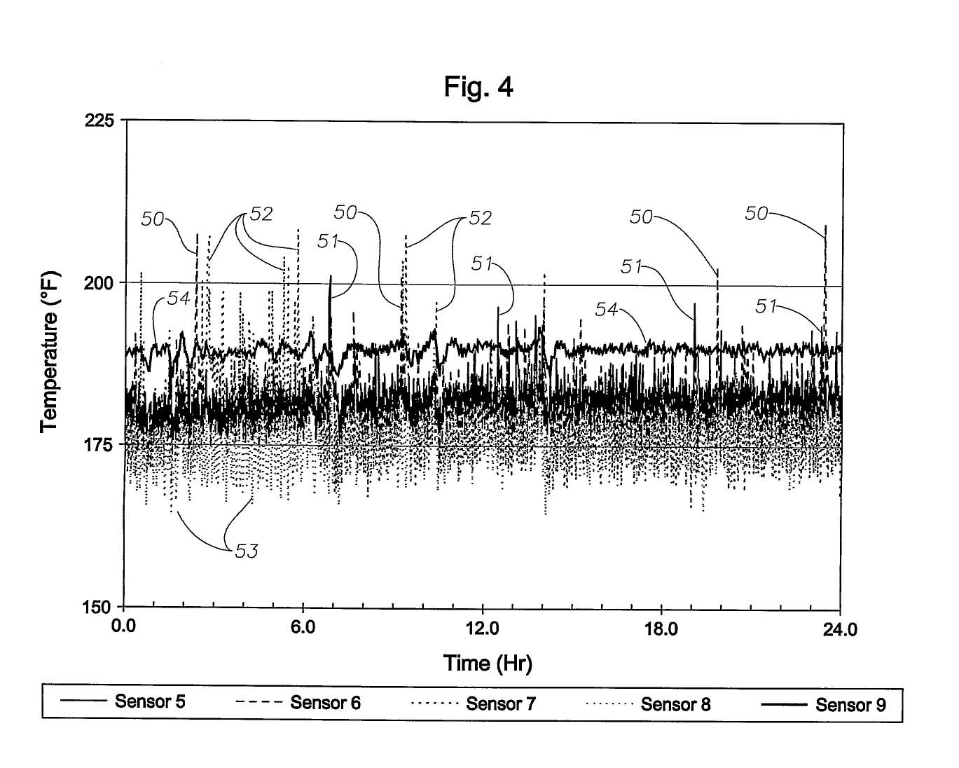

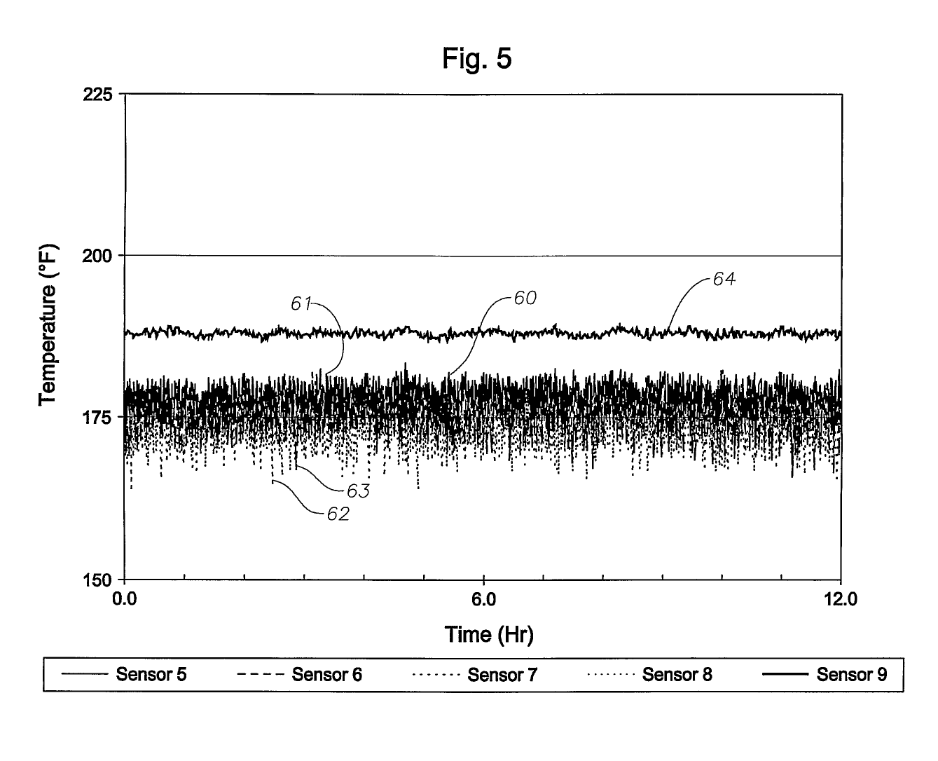

FIG. 4 is a graph of temperature data obtained from sensors 5, 6, 7, 8, and 9 during operation (over a 24-hour period) of the FIG. 1 system under conditions that resulted in sheeting. FIG. 5 is a graph of temperature data obtained from the same sensors during operation (over another 24-hour period) of the FIG. 1 system under conditions that did not result in significant sheeting. These data were obtained from the plant process data historian. The FIG. 4 and FIG. 5 data were obtained by sampling the output of each of sensors 5-9 every six seconds over a twenty-four hour time period and are shown plotted every fifteen seconds (after undergoing interpolation to aid in data compression).

In FIG. 4, curve 50 represents temperature data obtained from thermocouple sensor 6, curve 51 represents temperature data obtained from thermocouple sensor 5, curve 52 represents temperature data obtained from thermocouple sensor 7, curve 53 represents temperature data obtained from thermocouple sensor 8, and curve 54 represents temperature data obtained from sensor 9. Curves 50, 51, 52, and 53 indicate temperature spikes consistent with reactor sheeting (e.g., each of curves 50, 51, and 52 exhibits spikes at which the skin temperature exceeds the bed temperature indicated by curve 54), and indeed sheets were physically observed in the product produced during generation of the FIG. 4 temperature data. Sensors 5, 6, 7, and 8 should be implemented to have sufficiently fast response to be sensitive to temperature spikes of duration less than 10 seconds. The response time of the thermocouple should have a time constant of 1 second or less, preferably 0.1 second, using still water as the reference fluid in responding to a step change in water temperature from 1 to 100° C.

The behavior indicated by FIG. 4 contrasts with that indicated by the FIG. 5 temperature data. In FIG. 4, curve 60 represents temperature data obtained from thermocouple sensor 6, curve 61 represents temperature data obtained from thermocouple sensor 5, curve 62 represents temperature data obtained from thermocouple sensor 7, curve 63 represents temperature data obtained from thermocouple sensor 8, and curve 64 represents temperature data obtained from sensor 9. Curves 60, 61, 62, and 63 indicate stable operation, and indeed no sheeting was observed in the product produced during generation of the FIG. 5 data. All skin temperature readings indicated by curves 60, 61, 62, and 63 of FIG. 5 are below the bed temperature indicated by curve 64 (i.e., none of curves 60, 61, 62, and 63 exhibits spikes at which the skin temperature exceeds the bed temperature indicated by curve 64). FIG. 5 also indicates much tighter clustering of the skin temperature readings (less variation in amplitude of curves 60, 61, 62, and 63 over time) than does FIG. 4 (in which the amplitudes of curves 50, 51, 52, and 53 exhibit greater variation over time).

In accordance with the invention, temperature data indicative of reactor temperature as a function of time (typically, data indicative of skin temperature as a function of time during reactor operation) are Fourier-transformed to generate “transformed data.” The temperature data are indicative of N temperature functions, Tᵢ(t), where 1≦i≦N, each specifying temperature at a different location within the reactor at each time “t” of a continuous range or discrete set of times during reactor operation. Typically, the temperature data include data indicative of reactor skin temperature (as a function of time) at each of at least two different vertical positions along the reactor wall (in cases in which the reactor is vertically oriented) and also data indicative of bed temperature (as a function of time) at a location within the reactor relatively far from the reactor wall. The transformed data are indicative of N frequency spectra, including a frequency spectrum for each temperature function Tᵢ(t), and can be plotted as a function of frequency to provide N different frequency spectra. Each frequency spectrum has relatively high values at the major frequencies of the temperature function corresponding thereto.

The inventors have recognized (as a result of frequency response/power spectrum analyses of temperature data from fast-response temperature sensors) that during operation of many vertically oriented, fluidized bed reactors operating to produce polyolefins, low frequency (e.g., <0.05 cycles per minute) temperature variations dominate the power spectrum associated with each temperature sensor and are strongest at the bottom of each such reactor. These low frequency components are at least partly due to variations in flow patterns of polymer, gases and condensed liquids near the distributor plate (e.g., near plate 12 of FIG. 1) in the reactor. The inventors have also recognized that the natural frequency of the reactor's cooling control loop (which removes heat of reaction by cooling the fluid that enters the bottom of the fluidized bed) has a significant role in the low frequency temperature fluctuations. The temperature oscillations resulting from the natural frequency of the reactor cooling loop propagate upwards into the bed until they are obscured by mixing effects.

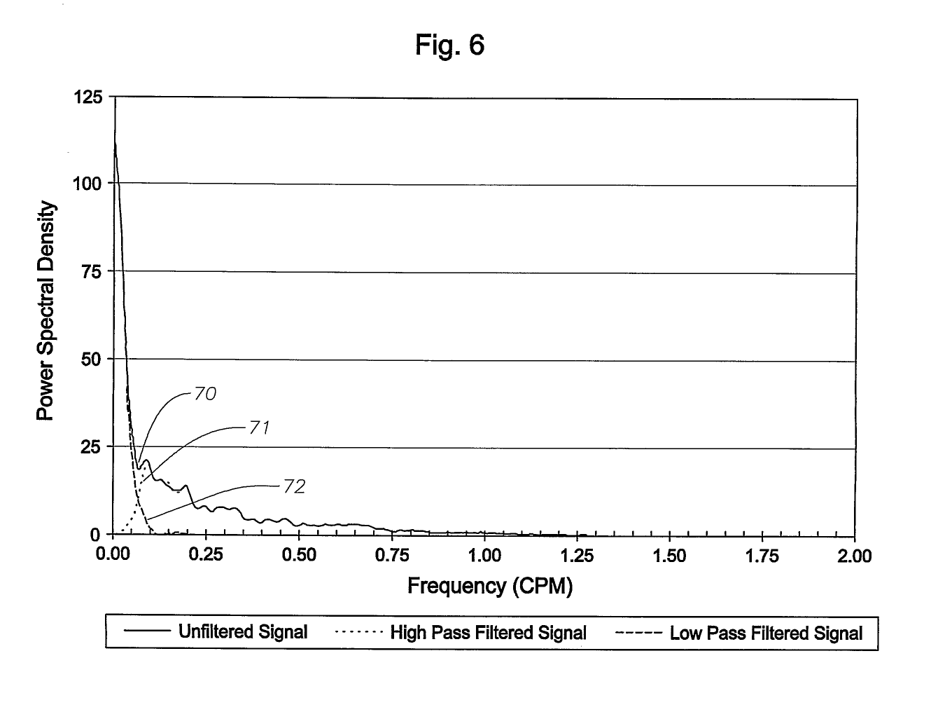

In accordance with a class of embodiments of the invention, the effect of the reactor cooling loop's natural frequency is determined and high-pass filtered from the transformed data. For example, the high-pass filtering can be accomplished using wavelet-based analysis. An example of such high-pass filtered, transformed data having frequency spectrum 71 is shown in FIG. 6. Frequency spectrum 70 of FIG. 6 is the frequency spectrum of the raw (unfiltered) transformed data that is high-pass filtered to generate spectrum 71. Spectrum 70 is generated by Fourier-transforming a set of temperature data of a type that could be obtained by sampling the output of one of skin temperature sensors 5, 6, 7, and 8 (of FIG. 1) over a time interval. The high-pass filtering of this set of skin temperature data is accomplished by subtracting curve 72 of FIG. 6 (which is a Daubechies order 2 wavelet) from spectrum 70, thereby generating spectrum 71. Spectrum 71 is not indicative of skin temperature oscillation resulting from the reactor cooling loop's natural frequency (which is a low frequency, equal to less than 0.05 cycles per minute), but spectrum 71 is much more significant than spectrum 70 from a process viewpoint since spectrum 71 is indicative of particle behavior at the reactor wall and is thus indicative of the majority of the process effects of interest in assessing fluidization quality (whereas such process effects cannot readily be discerned from spectrum 70).

To verify that control temperature oscillation (primarily occurring at the natural frequency of the reactor's cooling loop) was responsible for the filtered component (the difference between spectrum 70 and spectrum 71), the frequency spectrum of the control temperature oscillation (i.e., the frequency spectrum of the temperature, versus time, of the cooling fluid entering reactor 10) was determined separately. The deviation signal was totally absent from the raw signal. It was confirmed that the lowest frequency components of spectrum 70 (e.g., below 0.05 cycles per minute) were due to cooling fluid temperature (and thus bed temperature) oscillation. Conversely, it was confirmed that spectrum 71 was indicative of the majority of the process information of interest (i.e., the frequency spectrum of skin temperature as a function of time).

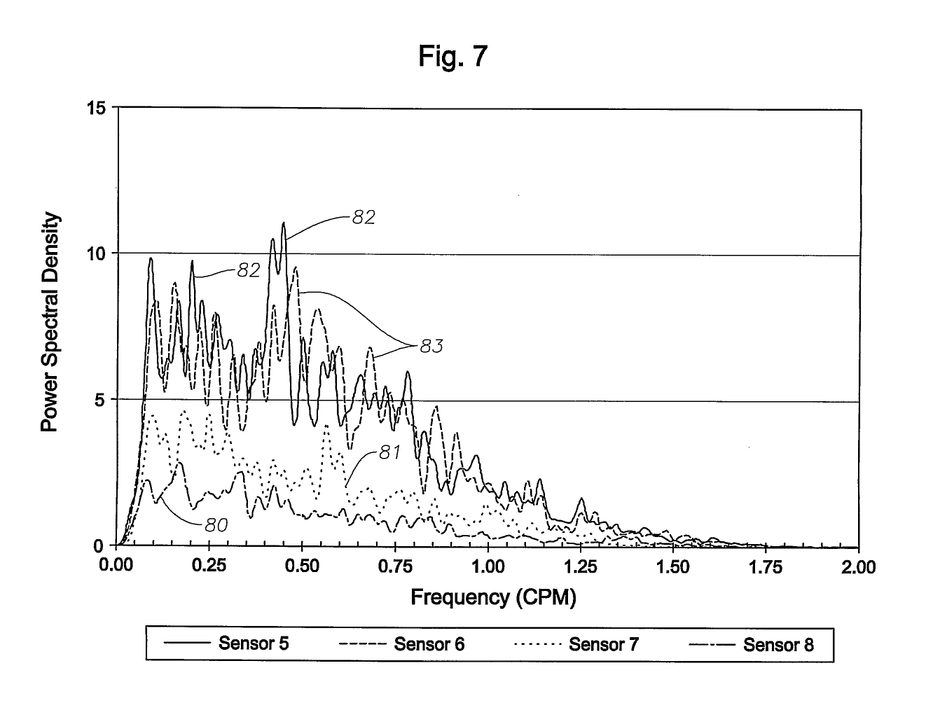

FIG. 7 is a graph of high-pass filtered, transformed data obtained by Fourier-transforming and then high-pass filtering a set of skin temperature data obtained from each of sensors 5, 6, 7, and 8 of FIG. 1 under conditions that did not result in significant sheeting. The same high-pass filter applied to generate spectrum 71 from spectrum 70 of FIG. 6 was applied to unfiltered, Fourier-transformed skin temperature data from sensors 5, 6, 7, and 8, to generate frequency spectra 80, 81, 82, and 83 of FIG. 7. In FIG. 7, curve 83 represents filtered, transformed temperature data obtained from thermocouple sensor 6, curve 82 represents filtered, transformed temperature data obtained from thermocouple sensor 5, curve 81 represents filtered, transformed temperature data obtained from thermocouple sensor 7, and curve 80 represents filtered, transformed temperature data obtained from thermocouple sensor 8. Each of frequency spectra 80, 81, 82, and 83 of FIG. 7 is broad and diffuse, having significant average amplitude throughout the frequency range from 0 to 1.5 cycles per minute. The relative magnitudes of spectra 80, 81, 82, and 83 are also distinctive. Spectra 82 and 83, the filtered, transformed skin temperature data from upper bed locations (7 and 8 ft above plate 12) have relatively higher values than do spectra 80 and 81, the filtered, transformed skin temperature data from lower bed locations (3 ft above plate 12). This is as expected for stable reactor operation (and good fluidization quality). The lower area of the reactor wall near to plate 12 has much more turbulence and mixing (than does the upper area of the reactor wall) resulting in frequent scrubbing of the wall. Hence, the residence time of particles at lower locations along the wall would be expected to be low and the corresponding frequency spectra (spectra 80 and 81) would be expected to have lower amplitudes than the amplitudes of the spectra (spectra 82 and 83) corresponding to reactor wall locations that are higher up (farther from plate 12). By contrast, the skin temperatures at higher elevations (farther from plate 12) would be expected to have more variation since they are less exposed to the high turbulence at lower elevations (nearer to plate 12) and the particles at the higher elevations would reside at the wall for a longer time than would the particles at the lower elevations. This results in more temperature variation and higher values for spectra 82 and 83 than for spectra 80 and 81. It is also apparent from FIG. 7 that the frequency components having significant amplitude are much more concentrated in the lower frequency range for the skin temperature data from higher elevations (spectra 82 and 83) than for the skin temperature data from lower elevations (spectra 80 and 81).

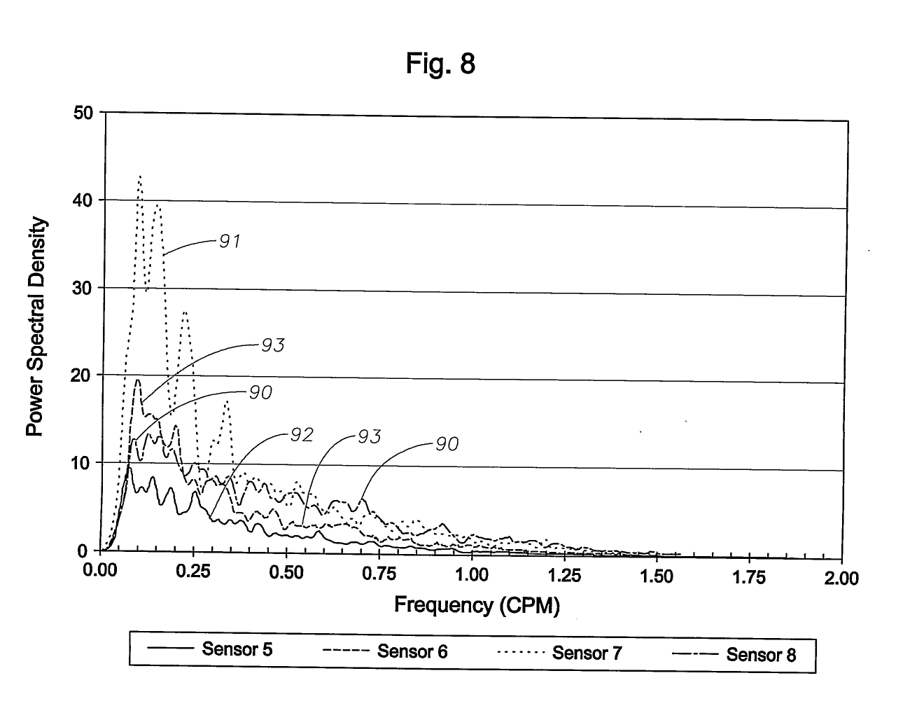

The fluidization quality assessment determined by the FIG. 7 data can be contrasted with that (for the case of sheeting) determined by the FIG. 8 data. FIG. 8 is a graph of high-pass filtered, transformed data obtained by Fourier-transforming and then high-pass filtering a set of skin temperature data obtained from each of sensors 5, 6, 7, and 8 of FIG. 1 under conditions that resulted in significant sheeting. The same high-pass filter applied to generate spectrum 71 from spectrum 70 of FIG. 6 was applied to unfiltered, Fourier-transformed skin temperature data from sensors 5, 6, 7, and 8, to generate frequency spectra 90, 91, 92, and 93 of FIG. 8. In FIG. 8, curve 93 represents filtered, transformed temperature data obtained from thermocouple sensor 6, curve 92 represents filtered, transformed temperature data obtained from thermocouple sensor 5, curve 91 represents filtered, transformed temperature data obtained from thermocouple sensor 7, and curve 90 represents filtered, transformed temperature data obtained from thermocouple sensor 8. Spectra 90, 91, 92, and 93 have greater amplitudes than do spectra 80, 81, 82, and 83 of FIG. 7. Spectra 90 and 91, the filtered, transformed skin temperature data from lower bed locations (3 ft above plate 12) have especially higher values than do corresponding spectra 80 and 81 from FIG. 7. The FIG. 8 data indicate a much wider range of fluctuation in the skin temperature than in the FIG. 7 case, and indicate that the particles near the reactor wall (especially at lower bed locations) are getting hotter than in the FIG. 7 case. Additionally, it is also apparent from FIG. 8 that the frequency components having significant amplitude are much more concentrated in the lower frequency range for spectra 90-93 than for spectra 80-83 of FIG. 7, indicating longer particle residence times at the wall in the FIG. 8 case than in the FIG. 7 case. Longer particle residence times at the wall in the FIG. 8 case than in the FIG. 7 case is believed to be the cause (or a major cause) of the higher average magnitudes of frequency spectra 90-93 (relative to the average magnitudes of frequency spectra 80-83), since the longer that particles reside at the reactor wall the hotter they get due to poor heat transfer (e.g., to the cooling fluid) at the wall than in the bed away from the wall.

In FIG. 7, each of spectra 80 and 81 is generated by processing a set of temperature data indicative of skin temperature as a function of time at a first elevation within the fluidized bed and each of spectra 82 and 83 is generated by processing a second set of temperature data indicative of skin temperature as a function of time at a second elevation (above the first elevation) within the fluidized bed. In accordance with some embodiments of the invention, processor 31 determines the average amplitude, A₂, of spectrum 82 (or 83) over a frequency range, and the average amplitude, A₁, of spectrum 80 (or 81) over the same frequency range. In some embodiments, determination by processor 31 that A₂ is substantially greater than A₁ is considered an indication of poor fluidization quality (and also of unstable reactor operation likely to result in sheeting), and determination by processor 31 that A₂ is not substantially greater than A₁ is considered an indication of good fluidization quality (or an indication that additional analysis is required to determine fluidization quality of reactor 10).

In some embodiments, processor 31 determines whether spectrum 82 (or 83) has a greater ratio of low frequency content to high frequency content than does spectrum 80 (or 81). This can be accomplished by partitioning the frequency range of each spectrum into a first segment (including frequencies less than a threshold frequency, fₜₕ, but no frequencies greater than fₜₕ) and a second segment (including frequencies greater than fₜₕ but no frequencies less than fₜₕ), and determining an average amplitude, A₂ₗ (where “1” denotes relatively low frequency) of spectrum 82 (or 83) over the first segment of the frequency range, an average amplitude, A₂ₕ (where “h” denotes relatively high frequency) of spectrum 82 (or 83) over the second segment of the frequency range, an average amplitude, A₁ₗ, of spectrum 80 (or 81) over the first segment of the frequency range, and an average amplitude, A₁ₕ, of spectrum 80 (or 81) over the second segment of the frequency range, and determining the relation between the ratios (A₂ₗ/A₂ₕ) and (A₁ₗ/A₁ₕ), for example by determining whether (A₂ₗ/A₂ₕ) is greater than (A₁ₗ/A₁ₕ). In some embodiments, determination that (A₂ₗ/A₂ₕ) is substantially greater than (A₁ₗ/A₁ₕ) is considered an indication of good fluidization quality (and of stable operation of reactor 10 unlikely to result in significant sheeting), and determination that (A₂ₗ/A₂ₕ) is not substantially greater than (A₁ₗ/A₁ₕ) is considered an indication of poor fluidization quality (and of unstable operation of reactor 10 likely to result in sheeting).

The temperature data that are Fourier transformed, and then high-pass filtered and plotted in FIGS. 6-8, can be collected with a data logger. For example, temperature data (from each skin temperature sensor) can be collected and saved in a file every 600 seconds, with the output of each skin temperature sensor being sampled at a rate of 10 Hz (10 times per second) for a time period of 300 seconds to provide a total of 3000 data points, the output of each skin temperature sensor then ignored for the next 300 seconds, the sampling then repeated to generate 3000 additional data points, the output of each skin temperature sensor then ignored for the next 300 seconds, and so on. The temperature data can then be processed (including by Fourier transforming and filtering the temperature data) off line (i.e., while acquisition of additional data samples temporarily ceases) to determine the frequency spectrum of interest for each skin temperature sensor for each of the 300-second (5 minute) sampling periods. Alternatively, temperature data can be processed on line (while generating additional temperature data samples) to determine the frequency spectra of interest in a continuous fashion.

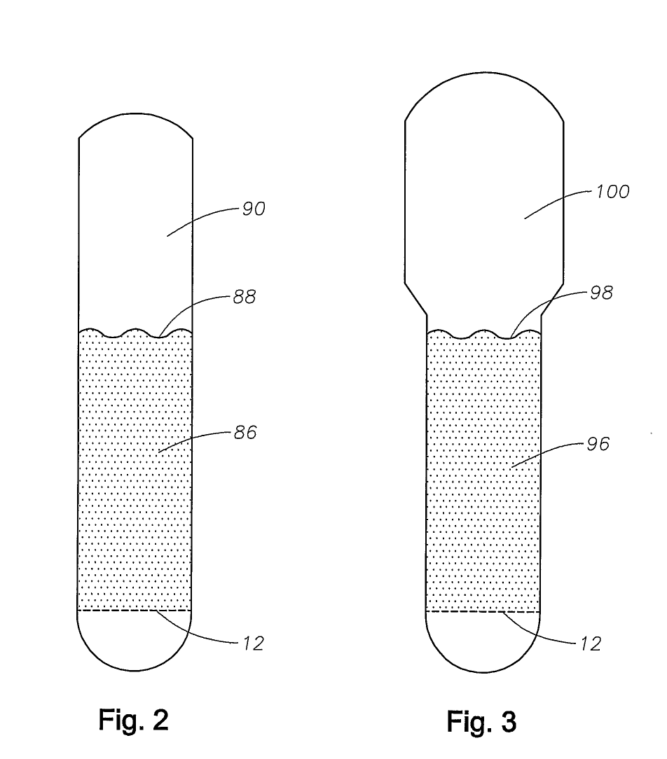

FIG. 2 is a simplified cross-sectional view of another fluidized bed reactor whose operation can be assessed in accordance with the invention. The FIG. 2 reactor has a cylindrical (straight) section between its bottom end and its top section, and a distributor plate 12 within the straight section. In operation, dense-phase surface 88 is the boundary between lean phase material present within the reactor (above dense-phase surface 88) and dense-phase material 86 within the reactor (in the volume bounded by the straight section, plate 12, and surface 88). In operation, freeboard surface 90 of the reactor is exposed to the lean phase material above surface 88.

FIG. 3 is a simplified cross-sectional view of another fluidized bed reactor whose operation can be assessed in accordance in accordance with the invention. The FIG. 3 reactor has a cylindrical (straight) section between its bottom end and its top section, and a distributor plate 12 within the straight section. The diameter of each horizontal cross-section of the top section is greater than the diameter of the straight section, but the top section of the FIG. 3 reactor is shaped differently than the top section of reactor 10 of FIG. 1. In operation of the FIG. 3 reactor, dense-phase surface 98 is the boundary between lean phase material present within the reactor (above dense-phase surface 98) and dense-phase material 96 within the reactor (in the volume bounded by the straight section, plate 12, and surface 98). In operation, freeboard surface 100 of the FIG. 3 reactor is exposed to the lean phase material above surface 98.

We next describe examples of commercial-scale reactions (e.g., commercial-scale, gas-phase fluidized-bed polymerization reactions) that can be analyzed or assessed in accordance with the invention. Some such reactions can occur in a reactor having the geometry of reactor 10 of FIG. 1, or the geometry of the FIG. 2 or FIG. 3 reactor. In different embodiments of the invention, performance of any of a variety of different reactors is analyzed in accordance with the invention.

In some embodiments, a continuous gas phase fluidized bed reactor is analyzed in accordance with the invention while it operates to perform polymerization as follows. The fluidized bed is made up of polymer granules. Gaseous feed streams of ethylene and hydrogen together with liquid comonomer are mixed together in a mixing tee arrangement and introduced below the reactor bed into the recycle gas line. Optionally, the comonomer is hexene. The individual flow rates of ethylene, hydrogen and comonomer are controlled to maintain fixed composition targets. The ethylene concentration is controlled to maintain a constant ethylene partial pressure. The hydrogen is controlled to maintain a constant hydrogen to ethylene mole ratio. The concentration of all gases is measured by an on-line gas chromatograph to ensure relatively constant composition in the recycle gas stream. A solid catalyst is injected directly into the fluidized bed using purified nitrogen as a carrier. Its rate is adjusted to maintain a constant production rate. The reacting bed of growing polymer particles is maintained in a fluidized state by the continuous flow of the make up feed and recycles gas through the reaction zone. In some implementations, a superficial gas velocity of 1-3 ft/sec is used to achieve this, and the reactor is operated at a total pressure of 300 psig. To maintain a constant reactor temperature, the temperature of the recycle gas is continuously adjusted up or down to accommodate any changes in the rate of heat generation due to the polymerization. The fluidized bed is maintained at a constant height by withdrawing a portion of the bed at a rate equal to the rate of formation of particulate product. The product is removed semi-continuously via a series of valves into a fixed volume chamber, which is simultaneously vented back to the reactor. This allows for highly efficient removal of the product, while at the same time recycling a large portion of the unreacted gases back to the reactor. This product is purged to remove entrained hydrocarbons and treated with a small steam of humidified nitrogen to deactivate any trace quantities of residual catalyst.

In other embodiments, a reactor is analyzed in accordance with the invention while it operates to perform polymerization using any of a variety of different processes (e.g., solution, slurry, or gas phase processes). For example, the reactor can be a fluidized bed reactor operating to produce polyolefin polymers by a gas phase polymerization process. This type of reactor and means for operating such a reactor are well known. In operation of such reactors to perform gas phase polymerization processes, the polymerization medium can be mechanically agitated or fluidized by the continuous flow of the gaseous monomer and diluent.

In some embodiments, a reactor whose performance is analyzed in accordance with the invention performs a polymerization process, which can be a continuous gas phase process (e.g., a fluid bed process). A fluidized bed reactor for performing such a process typically comprises a reaction zone and a so-called velocity reduction zone. The reaction zone comprises a bed of growing polymer particles, formed polymer particles and a minor amount of catalyst particles fluidized by the continuous flow of the gaseous monomer and diluent to remove heat of polymerization through the reaction zone. Optionally, some of the re-circulated gases may be cooled and compressed to form liquids that increase the heat removal capacity of the circulating gas stream when readmitted to the reaction zone. This method of operation is referred to as “condensed mode”. A suitable rate of gas flow may be readily determined by simple experiment. Make up of gaseous monomer to the circulating gas stream is at a rate equal to the rate at which particulate polymer product and monomer associated therewith is withdrawn from the reactor and the composition of the gas passing through the reactor is adjusted to maintain an essentially steady state gaseous composition within the reaction zone. The gas leaving the reaction zone is passed to the velocity reduction zone where entrained particles are removed. Finer entrained particles and dust may be removed in a cyclone and/or fine filter. The gas is passed through a heat exchanger wherein the heat of polymerization is removed, compressed in a compressor and then returned to the reaction zone.

The reactor temperature of the fluid bed process can range from 30° C. or 40° C. or 50° C. to 90° C. or 100° C. or 110° C. or 120° C. or 150° C. In general, the reactor temperature is operated at the highest temperature that is feasible taking into account the sintering temperature of the polymer product within the reactor. The polymerization temperature or reaction temperature typically must be below the melting or “sintering” temperature of the polymer to be formed. Thus, the upper temperature limit in one embodiment is the melting temperature of the polyolefin produced in the reactor.

In other embodiments, a reactor whose operation is analyzed in accordance with the invention effects polymerization by a slurry polymerization process. A slurry polymerization process generally uses pressures in the range of from 1 to 50 atmospheres and even greater and temperatures in the range of 0° C. to 120° C., and more particularly from 30° C. to 100° C. In a slurry polymerization, a suspension of solid, particulate polymer is formed in a liquid polymerization diluent medium to which ethylene and comonomers and often hydrogen along with catalyst are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, a branched alkane in one embodiment. The medium employed should be liquid under the conditions of polymerization and relatively inert. When a propane medium is used the process must be operated above the reaction diluent critical temperature and pressure. In one embodiment, a hexane, isopentane or isobutane medium is employed.

In other embodiments, a reactor whose performance is analyzed in accordance with the invention performs particle form polymerization, or a slurry process in which the temperature is kept below the temperature at which the polymer goes into solution. In other embodiments, a reactor whose performance is analyzed in accordance with the invention is a loop reactor or one of a plurality of stirred reactors in series, parallel, or combinations thereof. Non-limiting examples of slurry processes include continuous loop or stirred tank processes.

A reactor whose performance is analyzed in accordance with the invention can operate to produce homopolymers of olefins, e.g., ethylene, and/or copolymers, terpolymers, and the like, of olefins, particularly ethylene, and at least one other olefin. The olefins, for example, may contain from 2 to 16 carbon atoms in one embodiment; and in another embodiment, ethylene and a comonomer comprising from 3 to 12 carbon atoms in another embodiment; and ethylene and a comonomer comprising from 4 to 10 carbon atoms in yet another embodiment; and ethylene and a comonomer comprising from 4 to 8 carbon atoms in yet another embodiment. A reactor whose performance is analyzed in accordance with the invention can operate to produce polyethylenes. Such polyethylenes can be homopolymers of ethylene and interpolymers of ethylene and at least one α-olefin wherein the ethylene content is at least about 50% by weight of the total monomers involved. Exemplary olefins that may be utilized in embodiments of the invention are ethylene, propylene, 1-butene, 1-pentene, 1-hexene, 1-heptene, 1-octene, 4-methylpent-1-ene, 1-decene, 1-dodecene, 1-hexadecene and the like. Also utilizable herein are polyenes such as 1,3-hexadiene, 1,4-hexadiene, cyclopentadiene, dicyclopentadiene, 4-vinylcyclohex-1-ene, 1,5-cyclooctadiene, 5-vinylidene-2-norbornene and 5-vinyl-2-norbornene, and olefins formed in situ in the polymerization medium. When olefins are formed in situ in the polymerization medium, the formation of polyolefins containing long chain branching may occur.

In the production of polyethylene or polypropylene, comonomers may be present in the polymerization reactor. When present, the comonomer may be present at any level with the ethylene or propylene monomer that will achieve the desired weight percent incorporation of the comonomer into the finished resin. In one embodiment of polyethylene production, the comonomer is present with ethylene in a mole ratio range of from 0.0001 (comonomer:ethylene) to 50, and from 0.0001 to 5 in another embodiment, and from 0.0005 to 1.0 in yet another embodiment, and from 0.001 to 0.5 in yet another embodiment. Expressed in absolute terms, in making polyethylene, the amount of ethylene present in the polymerization reactor may range to up to 1000 atmospheres pressure in one embodiment, and up to 500 atmospheres pressure in another embodiment, and up to 200 atmospheres pressure in yet another embodiment, and up to 100 atmospheres in yet another embodiment, and up to 50 atmospheres in yet another embodiment.

Hydrogen gas is often used in olefin polymerization to control the final properties of the polyolefin. For some types of catalyst systems, it is known that increasing concentrations (partial pressures) of hydrogen increase the melt flow rate (MFR) and/or melt index (MI) of the polyolefin generated. The MFR or MI can thus be influenced by the hydrogen concentration. The amount of hydrogen in the polymerization can be expressed as a mole ratio relative to the total polymerizable monomer, for example, ethylene, or a blend of ethylene and hexane or propene. The amount of hydrogen used in some polymerization processes is an amount necessary to achieve the desired MFR or MI of the final polyolefin resin. In one embodiment, the mole ratio of hydrogen to total monomer (H₂:monomer) is greater than 0.00001. The mole ratio is greater than 0.0005 in another embodiment, greater than 0.001 in yet another embodiment, less than 10 in yet another embodiment, less than 5 in yet another embodiment, less than 3 in yet another embodiment, and less than 0.10 in yet another embodiment, wherein a desirable range may comprise any combination of any upper mole ratio limit with any lower mole ratio limit described herein. Expressed another way, the amount of hydrogen in the reactor at any time may range to up to 10 ppm in one embodiment, or up to 100 or 3000 or 4000 or 5000 ppm in other embodiments, or between 10 ppm and 5000 ppm in yet another embodiment, or between 500 ppm and 2000 ppm in another embodiment.

A reactor whose performance is analyzed in accordance with the invention can be an element of a staged reactor employing two or more reactors in series, wherein one reactor may produce, for example, a high molecular weight component and another reactor may produce a low molecular weight component.

A reactor whose performance is analyzed in accordance with the invention can be implement a slurry or gas phase process in the presence of a bulky ligand metallocene-type catalyst system and in the absence of, or essentially free of, any scavengers, such as triethylaluminum, trimethylaluminum, tri-isobutylaluminum and tri-n-hexylaluminum and diethyl aluminum chloride, dibutyl zinc and the like. By “essentially free”, it is meant that these compounds are not deliberately added to the reactor or any reactor components, and if present, is present to less than 1 ppm in the reactor.

A reactor whose performance is analyzed in accordance with the invention can employ one or more catalysts combined with up to 10 wt % of a metal-fatty acid compound, such as, for example, an aluminum stearate, based upon the weight of the catalyst system (or its components). Other metals that may be suitable include other Group 2 and Group 5-13 metals. In other embodiments, a solution of the metal-fatty acid compound is fed into the reactor. In other embodiments, the metal-fatty acid compound is mixed with the catalyst and fed into the reactor separately. These agents may be mixed with the catalyst or may be fed into the reactor in a solution or a slurry with or without the catalyst system or its components.

In a reactor whose performance is analyzed in accordance with the invention, supported catalyst(s) can be combined with activators and can be combined by tumbling and/or other suitable means, with up to 2.5 wt % (by weight of the catalyst composition) of an antistatic agent, such as an ethoxylated or methoxylated amine, an example of which is Kemamine AS-990 (ICI Specialties, Bloomington Del.). Other antistatic compositions include the Octastat family of compounds, more specifically Octastat 2000, 3000, and 5000.

The metal fatty acids and antistatic agents can also be added as either solid slurries or solutions as separate feeds into the reactor. One advantage of this method of addition is that it permits on-line adjustment of the level of the additive.

Examples of polymers that can be produced by a reactor whose performance is analyzed in accordance with the invention include the following: homopolymers and copolymers of C2-C18 alpha olefins; polyvinyl chlorides, ethylene propylene rubbers (EPRs); ethylene-propylene diene rubbers (EPDMs); polyisoprene; polystyrene; polybutadiene; polymers of butadiene copolymerized with styrene; polymers of butadiene copolymerized with isoprene; polymers of butadiene with acrylonitrile; polymers of isobutylene copolymerized with isoprene; ethylene butene rubbers and ethylene butene diene rubbers; and polychloroprene; norbornene homopolymers and copolymers with one or more C2-C18 alpha olefin; terpolymers of one or more C2-C18 alpha olefins with a diene.

Monomers that can be present in a reactor whose performance is analyzed in accordance with the invention include one or more of: C2-C18 alpha olefins such as ethylene, propylene, and optionally at least one diene, for example, hexadiene, dicyclopentadiene, octadiene including methyloctadiene (e.g., 1-methyl-1,6-octadiene and 7-methyl-1,6-octadiene), norbornadiene, and ethylidene norbornene; and readily condensable monomers, for example, isoprene, styrene, butadiene, isobutylene, chloroprene, acrylonitrile, cyclic olefins such as norbornenes.

A reactor whose performance is analyzed in accordance with some embodiments of the invention can perform fluidized bed polymerizations (e.g., mechanically stirred and/or gas fluidized). The reactor can be used to perform any type of fluidized polymerization reaction and the reaction can be carried out in a single reactor or multiple reactors such as two or more reactors in series.

In various embodiments, any of many different types of polymerization catalysts can be used in a polymerization process performed by a reactor whose performance is analyzed in accordance with the present invention. A single catalyst may be used, or a mixture of catalysts may be employed, if desired. The catalyst can be soluble or insoluble, supported or unsupported. It may be a prepolymer, spray dried with or without a filler, a liquid, or a solution, slurry/suspension or dispersion. These catalysts are used with cocatalysts and promoters well known in the art. Typically these are alkylaluminums, alkylaluminum halides, alkylaluminum hydrides, as well as aluminoxanes. For illustrative purposes only, examples of suitable catalysts include Ziegler-Natta catalysts, Chromium based catalysts, Vanadium based catalysts (e.g., vanadium oxychloride and vanadium acetylacetonate), Metallocene catalysts and other single-site or single-site-like catalysts, Cationic forms of metal halides (e.g., aluminum trihalides), anionic initiators (e.g., butyl lithiums), Cobalt catalysts and mixtures thereof, Nickel catalysts and mixtures thereof, rare earth metal catalysts (i.e., those containing a metal having an atomic number in the Periodic Table of 57 to 103), such as compounds of cerium, lanthanum, praseodymium, gadolinium and neodymium.

In various embodiments, a polymerization process performed by a reactor whose performance is assessed in accordance with the invention can employ other additives, such as (for example) inert particulate particles.

It should be understood that while some embodiments of the present invention are illustrated and described herein, the invention is not to be limited to the specific embodiments described and shown.

1. A method for assessing fluidization quality of a fluidized bed reactor, said method including the steps of:
(a) generating at least one set of temperature data, such that each said set of temperature data is indicative of temperature at a location within the reactor as a function of time during operation of the reactor;
(b) generating transformed data by performing a Fourier transform on each said set of temperature data;
(c) generating filtered, transformed data by high-pass filtering the transformed data to remove low frequency components thereof; and
(d) determining at least one indication of the fluidization quality from the filtered, transformed data.

2. The method of claim 1, wherein the reactor has a cooling control loop having a natural frequency, and the low frequency components removed during step (c) include a frequency component whose frequency is said natural frequency.

3. The method of claim 2, wherein a fluidized bed is present within the reactor during operation, and step (a) includes the step of generating at least two sets of skin temperature data, each indicative of skin temperature as a function of time at a different elevation within the fluidized bed.

4. The method of claim 1, wherein a fluidized bed is present within the reactor during operation, and step (a) includes the step of generating at least two sets of skin temperature data, each indicative of skin temperature as a function of time at a different elevation within the fluidized bed.

5. The method of claim 4, wherein step (a) also includes the step of generating a set of bed temperature data indicative of bed temperature within the fluidized bed.

6. The method of claim 4, wherein step (a) includes the step of using thermocouple sensors to generate a first set of temperature data indicative of skin temperature as a function of time at a first elevation within the fluidized bed, and a second set of temperature data indicative of skin temperature as a function of time at a second elevation, above the first elevation, within the fluidized bed.

7. The method of claim 4, wherein step (a) includes the step of generating a first set of temperature data indicative of skin temperature as a function of time at a first elevation within the fluidized bed and a second set of temperature data indicative of skin temperature as a function of time at a second elevation, above the first elevation, within the fluidized bed, step (c) includes the steps of generating a first set of filtered, transformed data having average amplitude, A₁, over a frequency range, from a transformed version of the first set of temperature data, and generating a second set of filtered, transformed data having average amplitude, A₂, over the frequency range, from a transformed version of the second set of temperature data, and step (d) includes the step of determining whether the average amplitude, A₂, is greater than the average amplitude, A₁.

8. The method of claim 7, wherein step (d) includes the step of determining whether the average amplitude, A₂, is substantially greater than the average amplitude, A₁.

9. The method of claim 4, wherein step (a) includes the step of generating a first set of temperature data indicative of skin temperature as a function of time at a first elevation within the fluidized bed and a second set of temperature data indicative of skin temperature as a function of time at a second elevation, above the first elevation, within the fluidized bed, step (c) includes the steps of generating a first set of filtered, transformed data having average amplitude, A₁, over a frequency range, from a transformed version of the first set of temperature data, and generating a second set of filtered, transformed data having average amplitude, A₂, over the frequency range, from a transformed version of the second set of temperature data, and step (d) includes the step of determining whether the second set of filtered, transformed data has a greater ratio of low frequency content to high frequency content than does the first set of filtered, transformed data.

10. The method of claim 9, wherein step (d) includes the steps of:
partitioning the frequency range into a first segment including frequencies less than a threshold frequency, fₜₕ, but no frequencies greater than fₜₕ, and a second segment including frequencies greater than fₜₕ, but no frequencies less than fₜₕ, and determining an average amplitude, A₂ₗ, of the second set of filtered, transformed data over the first segment of the frequency range, an average amplitude, A₂ₕ, of the second set of filtered, transformed data over the second segment of the frequency range, an average amplitude, A₁ₗ, of the first set of filtered, transformed data over the first segment of the frequency range, and an average amplitude, A₁ₕ, of the first set of filtered, transformed data over the second segment of the frequency range.

11. The method of claim 10, wherein step (d) also includes the step of determining whether (A₂ₗ/A₂ₕ) is greater than (A₁ₗ/A₁ₕ).

12. The method of claim 4, wherein step (a) includes the step of generating a first set of temperature data indicative of skin temperature, as a function of time during a first time interval, at a first elevation within the fluidized bed, and a second set of temperature data indicative of skin temperature, as a function of time during a second time interval later than the first time interval, at the first elevation within the fluidized bed, step (c) includes the steps of generating a first set of filtered, transformed data from a transformed version of the first set of temperature data, and generating a second set of filtered, transformed data from a transformed version of the second set of temperature data, and step (d) includes the steps of:
identifying a frequency range; and
determining whether the second set of filtered, transformed data has greater average amplitude over the frequency range than does the first set of filtered, transformed data.

13. The method of claim 1, wherein step (d) includes the step of determining whether the filtered, transformed data are indicative of at least one diffuse frequency spectrum.

14-17. (canceled)

18. A system for assessing fluidization quality of a fluidized bed reactor, said system including:
a set of temperature sensors, each of the sensors configured to generate a set of temperature data indicative of temperature at a location within the reactor as a function of time during operation of the reactor; and
a subsystem coupled and configured to receive each said set of temperature data, to generate transformed data by performing a Fourier transform on each said set of temperature data, to generate filtered, transformed data by high-pass filtering the transformed data to remove low frequency components thereof, and to determine at least one indication of the fluidization quality from the filtered, transformed data.

19. The system of claim 18, wherein the reactor has a cooling control loop having a natural frequency, and the low frequency components removed by the subsystem include a frequency component whose frequency is said natural frequency.

20. The system of claim 19, wherein a fluidized bed is present within the reactor during operation of said reactor, and the temperature sensors are configured to generate at least two sets of skin temperature data, each indicative of skin temperature as a function of time at a different elevation within the fluidized bed.

21. (canceled)

22. The system of claim 20, wherein the temperature sensors are thermocouple sensors configured to generate the sets of skin temperature data.

23. The system of claim 20, wherein the temperature sensors are configured to generate a first set of temperature data indicative of skin temperature as a function of time at a first elevation within the fluidized bed and a second set of temperature data indicative of skin temperature as a function of time at a second elevation, above the first elevation, within the fluidized bed, and the subsystem is configured to generate a first set of filtered, transformed data having average amplitude, A₁, over a frequency range, from a transformed version of the first set of temperature data, to generate a second set of filtered, transformed data having average amplitude, A₂, over the frequency range, from a transformed version of the second set of temperature data, and to determine whether the average amplitude, A₂, is greater than the average amplitude, A₁.

24. The system of claim 23, wherein the subsystem is configured to determine whether the average amplitude, A₂, is substantially greater than the average amplitude, A₁.

25. The system of claim 20, wherein the temperature sensors are configured to generate a first set of temperature data indicative of skin temperature as a function of time at a first elevation within the fluidized bed and a second set of temperature data indicative of skin temperature as a function of time at a second elevation, above the first elevation, within the fluidized bed, and the subsystem is configured to generate a first set of filtered, transformed data having average amplitude, A₁, over a frequency range, from a transformed version of the first set of temperature data, to generate a second set of filtered, transformed data having average amplitude, A₂, over the frequency range, from a transformed version of the second set of temperature data, and to determine whether the second set of filtered, transformed data has a greater ratio of low frequency content to high frequency content than does the first set of filtered, transformed data.

26. The system of claim 25, wherein the subsystem is configured to determine a partition of the frequency range including a first segment including frequencies less than a threshold frequency, fₜₕ, but no frequencies greater than fₜₕ, and a second segment including frequencies greater than fₜₕ, but no frequencies less than fₜₕ, and to determine an average amplitude, A₂ₗ, of the second set of filtered, transformed data over the first segment of the frequency range, an average amplitude, A₂ₕ, of the second set of filtered, transformed data over the second segment of the frequency range, an average amplitude, A₁ₗ, of the first set of filtered, transformed data over the first segment of the frequency range, and an average amplitude, A₁ₕ, of the first set of filtered, transformed data over the second segment of the frequency range.

27. The system of claim 26, wherein the subsystem is configured to determine whether (A₂ₗ/A₂ₕ) is greater than (A₁ₗ/A₁ₕ).

28. The system of claim 20, wherein the temperature sensors are configured to generate a first set of temperature data indicative of skin temperature, as a function of time during a first time interval, at a first elevation within the fluidized bed, and a second set of temperature data indicative of skin temperature, as a function of time during a second time interval later than the first time interval, at the first elevation within the fluidized bed, and the subsystem is configured to generate a first set of filtered, transformed data from a transformed version of the first set of temperature data, to generate a second set of filtered, transformed data from a transformed version of the second set of temperature data, to identify a frequency range, and to determine whether the second set of filtered, transformed data has greater average amplitude over the frequency range than does the first set of filtered, transformed data.

29. The system of claim 18, wherein the subsystem is configured to determine whether the filtered, transformed data are indicative of at least one diffuse frequency spectrum.

30. The method of claim 18, wherein the at least one set of temperature data or the at least two sets of temperature data are generated using fast response temperature sensors.

31. (canceled)
